(19) United States
(12) Patent Application Publication
(10) Pub. No.: US 2016/0301527 A1
(43) Pub. Date: Oct. 13, 2016

(54) METHOD FOR ENCRYPTION AND DECRYPTION OF SYMBOLS THROUGH SINGLE-USE, REAL-TIME CHANGING CODES OF GREAT LENGTH AND COMPLEXITY

(71) Applicants: Zdravko Mijailovic, Chicago, IL (US); Danijela Mijailovic, Chicago, IL (US)

(72) Inventors: Zdravko Mijailovic, Chicago, IL (US); Danijela Mijailovic, Chicago, IL (US)

(21) Appl. No.: 14/685,593

(22) Filed: Apr. 13, 2015

(51) Int. Cl. H04L 9/08

(52) U.S. Cl. CPC H04L 9/0816; H04L 9/0869; H04L 2209/24

(57) ABSTRACT

The method of encryption and decryption of each symbol takes a single-use code, changes the used code and changes all relationships within the execution system in real time.

It consists of pairs of symbols and random natural numbers, and strings of codes.

In the beginning of communication, the sender and receiver are familiar with all initial conditions.

The value used for performing all changes is revealed after the execution of each respective step of encoding and decoding every symbol.

This value depends on each step, it changes reiteratively and is not directly attached to the symbol being encoded/decoded.

Prior to the execution of any step, the value of this change is unknown to either sender or receiver of the message. The total change of codes and numbers, as well as of all relationships, is increased with each step of utilizing this method.

### TECHNICAL FIELD

The presented invention generally applies to the field of securing the information content from unwanted discovery (cryptography), mainly in digital mode, but in other information exchange modes as well.

### BACKGROUND

One of the crucial issues of information exchange is preventing unwanted discovery of information content. Existing communication security systems available to public do not always provide sufficiently strong protection of information transfer, some of which are complex, overburdening communication system, while others are too costly for mass utilization.

The main goal is to provide strong, reliable, simple, agile, and affordable protection of information exchange, whose theoretical probability of being discovered is close or equal to zero.

### SUMMARY

The invention represents a method of encryption and decryption of each symbol respectively with a single-use and immediate change of the used code in real time. The method is composed of pairs of symbols and random whole numbers and a string of codes. Through the numbers, the codes within the string are connected to the symbols indirectly and for a single use.

In the beginning, the sender and receiver are familiar with all initial conditions: the pairs, codes, exact direction and the mode of receiving and change of the codes as well as the change of random numbers.

Through the exact order of the process of coding and decoding of each symbol, all values and all relationships in the process of information exchange are changed (the values of randomly selected whole numbers, the relationship between the number and the symbol, the values of the codes and mutual arrangement of the codes).

The participants of the information exchange use the exact order and, one step at a time, successively exchange the information. Each execution step of this encryption method changes all values and relationships within the system. At each encryption step, the value which is used to perform the change of all values and all relationships in the exchange of the information is hidden within the code.

Prior to the execution of any step, the value of this change is unknown to both sender and receiver of the message. Being falimiar only with initial values of encyption system and knowing all previously executed steps, allows understanding of the value of the change which is hidden in the code being sent.

Unwanted discovery of any symbol during the beginning of the process without knowing other values is useless since each step repeatedly changes all relationships within the encryption system.

The encryption strength is increased with each step of this method.

### BRIEF DESCRIPTION OF DRAWINGS

FIG. 1 Demonstrates the scheme, relationships and interconnection of the basic units of encryption and decryption methods;

FIG. 2 Schematically illustrates the relationships between symbols and random whole numbers, and the direction in which the positions of these numbers change;

FIG. 3 Illustrates the list of codes and the direction in which the position of the code is read and changed

FIG. 4A, FIG. 4B and FIG. 4C demonstrate the scheme of establishing connection;

FIG. 4A Demonstrates the scheme of a random code selection by sender A and sending of this code to receiver B;

FIG. 4B Demonstrates the reception of code (Codeᵣ), taking the code which is next on the list (Codeᵣ₊₁) according to the direction of position (r+1) and sending it back to sender A;

FIG. 4C Demonstrates the scheme of “zero code” which is now familiar to and common for both sender and recipient;

FIG. 5 Demonstrates the flowchart of discrete steps in the process of establishing connection;

FIG. 6 Illustrates the process of encryption and immediate change in the value and position of random numbers and codes;

FIG. 7 Illustrates the flowchart of discrete steps of encryption and immediate change in the value and position of random numbers and codes ;

FIG. 8 Illustrates the process of decryption and immediate change in the value of random numbers and codes;

FIG. 9 Illustrates the flowchart of discrete steps of decryption and immediate change in the value and position of random numbers and codes;

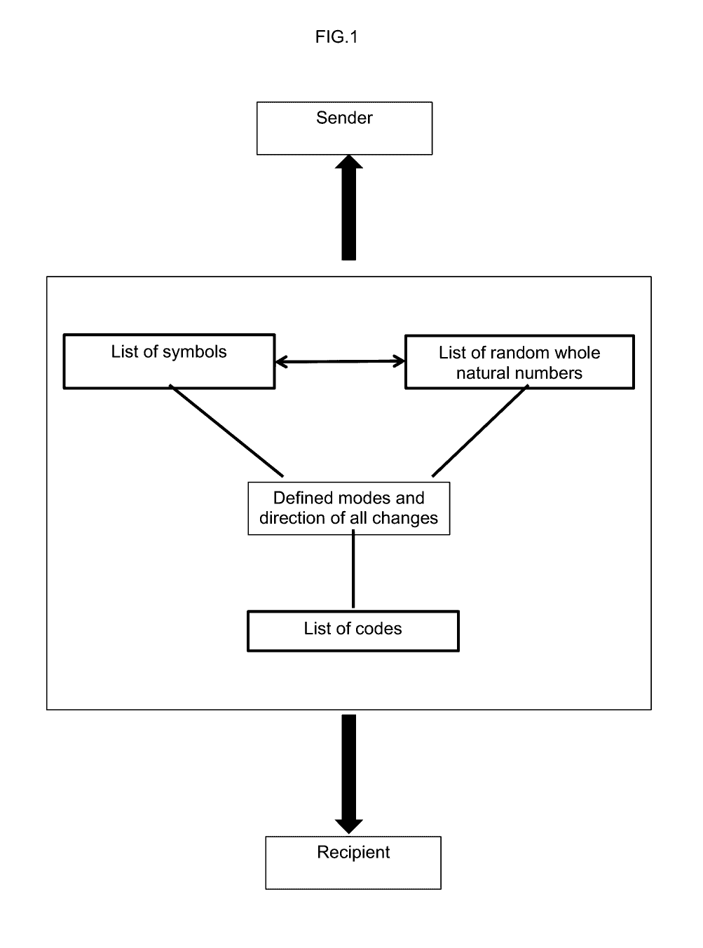

### DETAILED DESCRIPTION

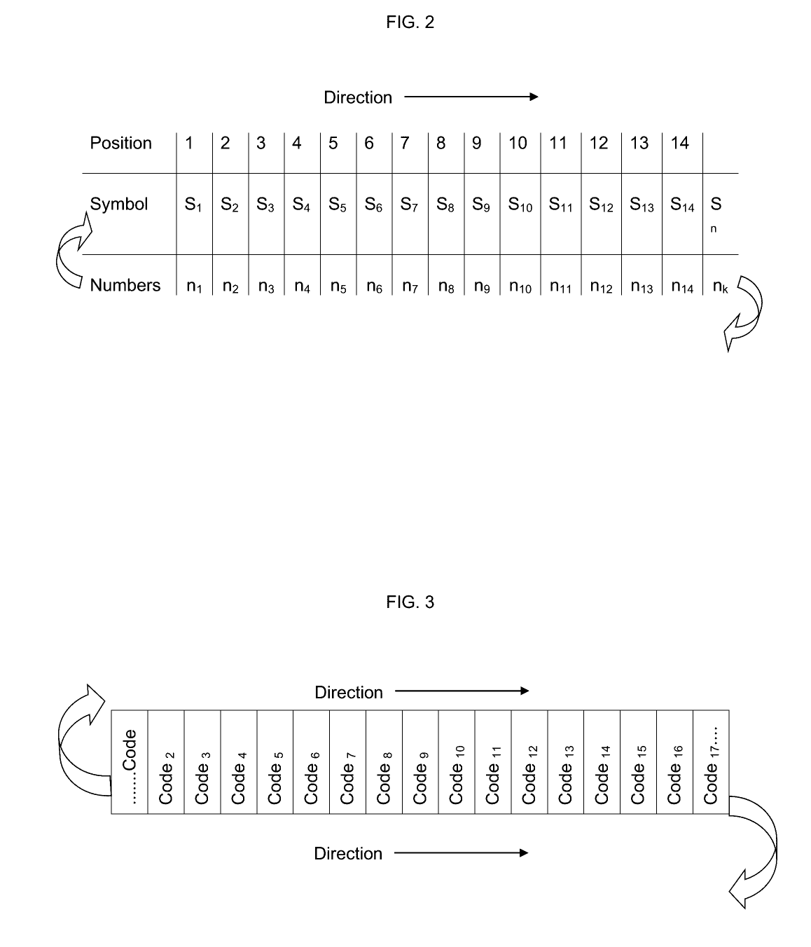

All pairs, codes and exact directions, FIG. 2, FIG. 3, are known to both sender and receiver at the start of information exchange.

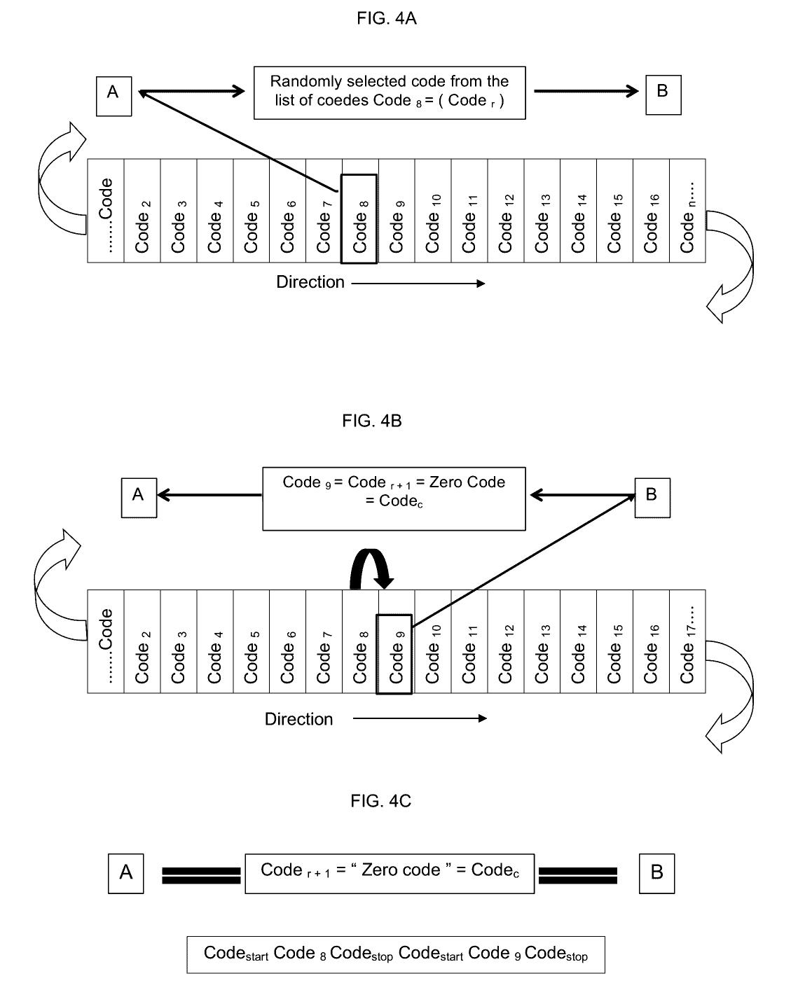

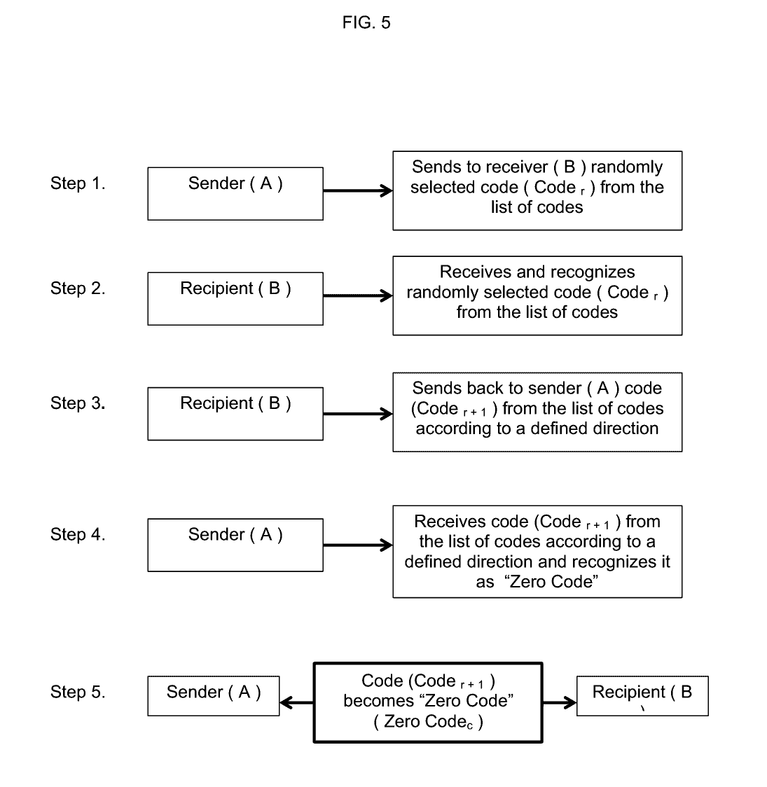

The process is initialized by establishing communication and mutual recognition of participants, FIG. 4A, FIG. 4B, FIG. 4C and FIG. 5, in communication. Sender A sends to recipient B a randomly selected code (Codeᵣ) from the list of codes as illustrated in FIG. 4A. Recipient B performs the search of the list of codes and finds the value and exact position of the sent code (Codeᵣ). Recepient B returns the code which is positioned next to the received code (Codeᵣ₊₁), FIG. 4B, according to a defined direction of code reading.

The returned code (Codeᵣ₊₁) represents the initial zero code (Code_{c}) and it signalizes that sender A and recipient B mutually recognized one another. As shown in FIG. 4C, the position of the zero code is now known to both information sender and receiver.
That is a referential position for obtaining codes and exchanging all information for sender A and recipient B, FIG.5. This referential code (Codeᵣ₊₁) is only valid for this information exchange cycle between A and B. After the information exchange has been completed, or communication line has been cut, this referential code (Code_{c}) is no longer valid. To establish connection again the whole cycle is repeated, with a new referential zero code, a completely different code from a completely altered list of codes.

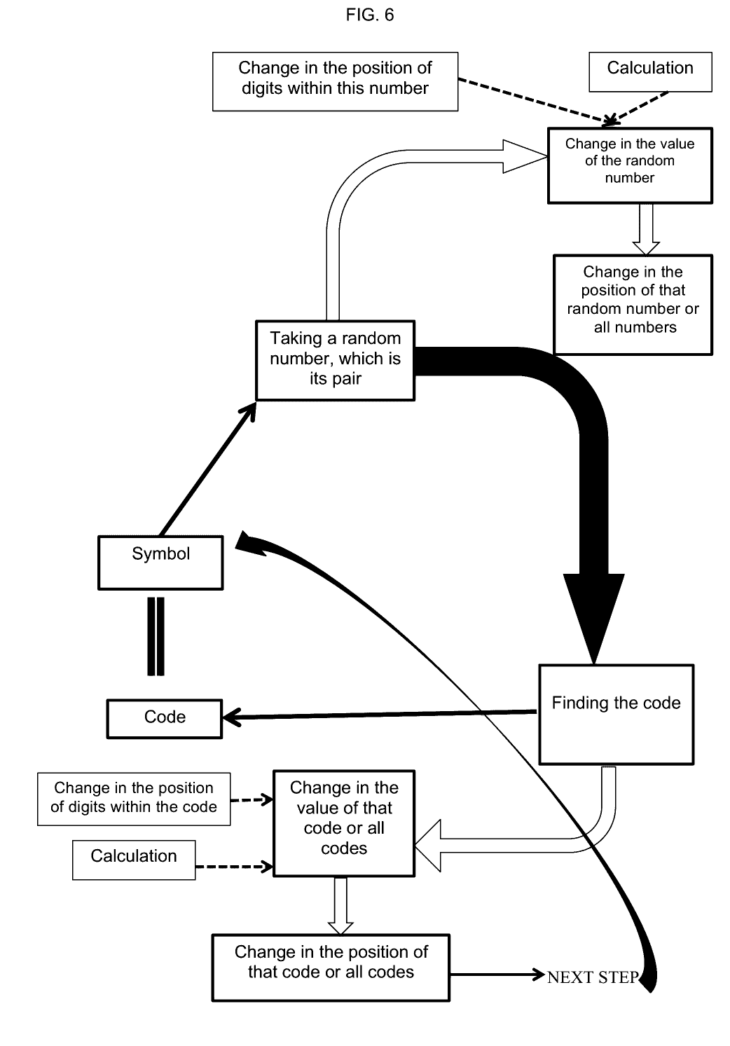

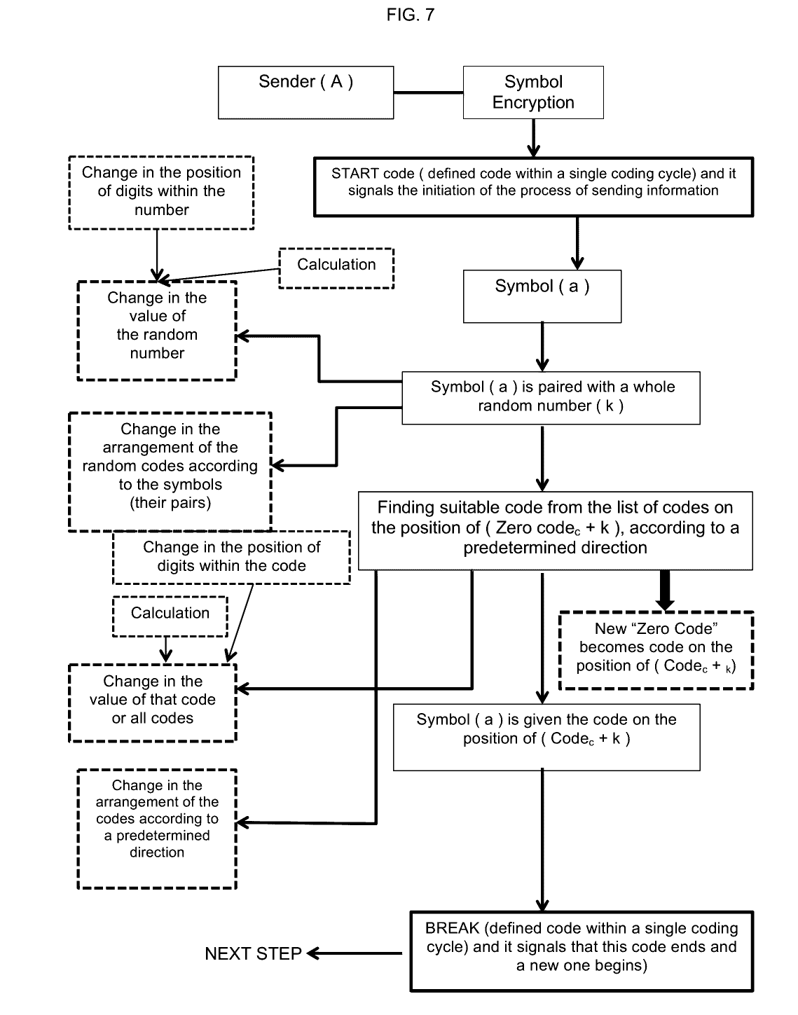

The encryption process is shown in FIG. 6 and FIG. 7 and it starts with a symbol which is to be coded.

The recipient takes number (k) which is at that time assigned to symbol (a) and it represents the position of code (Code_{c}+k), according to a predetermined direction. Thus, the code corresponding to symbol (a) is the code whose position on the list of codes is away from the zero code (Code_{c}) for the number of positions equal to (k) in a defined direction.

Immediately upon determining the code, this single-use number changes its value in two ways: the first way is to change places of its units digit and its first digit; the second way is through calculation, i.e. to add to this whole number or to subtract from it the value of its units digit;

Also, the used random code moves on the list of random numbers in a defined direction for a number of positions equal to the value of its units digit. In that way, all numbers which are positioned between the new and earlier position of the used number move for one place in a defined direction. The result is to completely change the relationship of the pairs and random numbers in that part of the list of random numbers.

This used code on the position of (Code_{c}+k) will represent a “New Zero Code” for the process of coding the following symbol and this is repeated in this way throughout the exchange process.

Within the same action, the sender changes the value of the used code on the position of (Code_{c}+k), in a way that appends the used random number (k) to the code at its end.

Also, the used code moves on the list of codes in a defined direction for the number of places equal to the value of the units digit of the used random number. In that way all codes between the new and the earlier position of the used code move for one place.

The coding of the following symbol is performed by repeating all these steps.

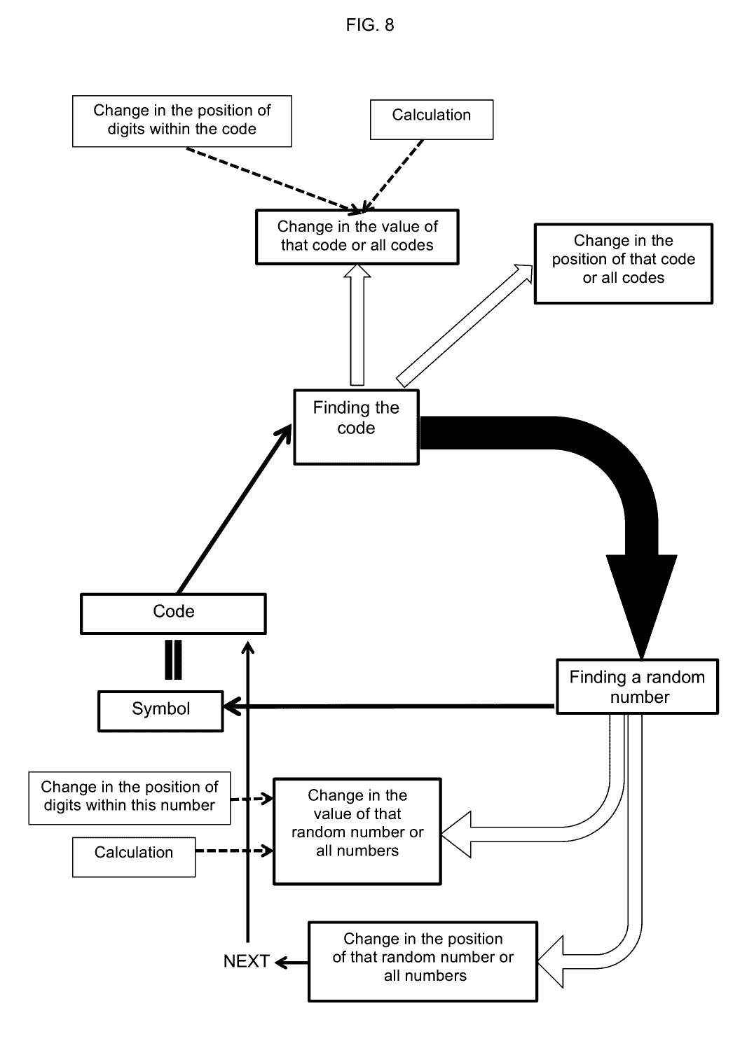

The recipient initializes the decoding process as shown in FIG. 8, in reverse, immediately upon receiving the code for the first symbol.

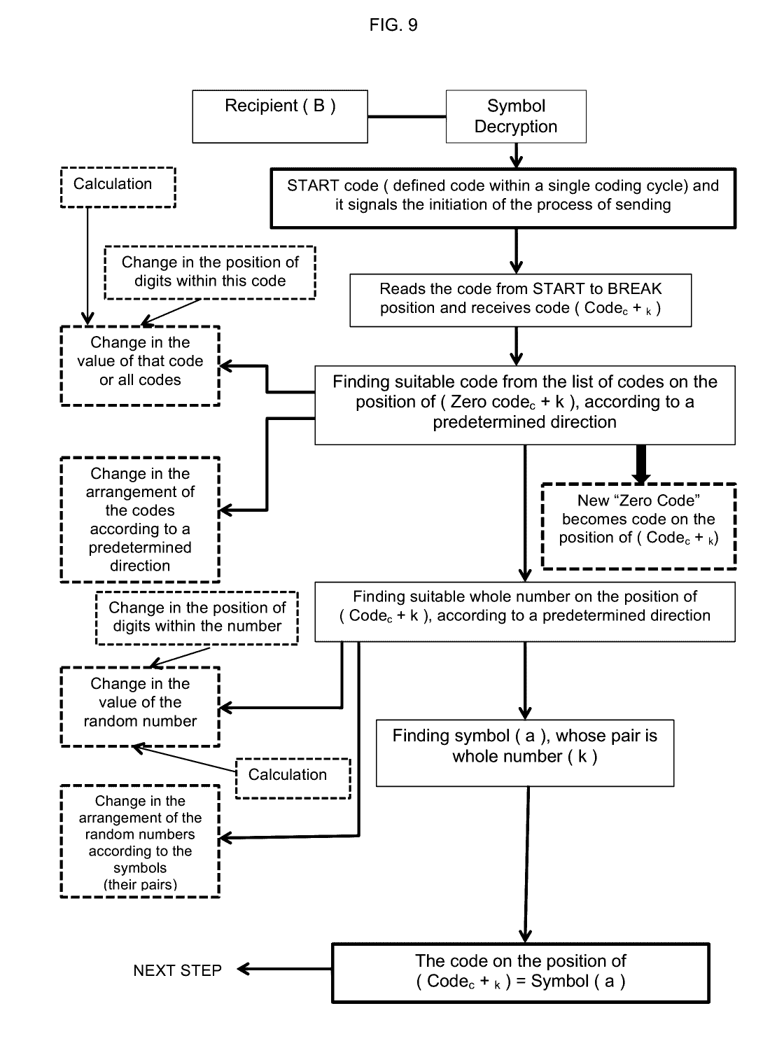

He first receives START code (defined code within a single coding cycle) and learns that the information sending process begins, as shown in FIG. 9. Then he reads the code from START to BREAK position, and receives the code on the position of ( Code_{c}+k). With the position of (Code_{c}) being familiar, the receiver reads number (k). Using the value of number (k) on the list of pairs of symbols and numbers, it decodes symbol (a), and learns that the code on the position of (Code_{c}+k) actually represents symbol (a).

Also, the recepient learns that this code will be the “new zero code” for the process of decoding the following symbol.

Immediately, just as the sender did, the recepient performs all changes in the value and positions of numbers and codes as shown in [0023], [0024], [0026] and [0027].

The process of decoding is continued in the same manner, by repeating all steps.

What is claimed is:

1. The method of encryption of each symbol during information exchange consists of:
a. the set of codes and pairs, each pair consisting of a symbol and a randomly selected whole number;
b. the real-time change in the value and position of the random number in relation to the symbol, immediately upon each use;
c. the real-time change in the value and position of the code, immediately upon each step of utilization;
d. the real-time change in the referential position of “zero code” used to determine the position of requested code, immediately upon each step of utilization;
e. pairing up the symbols with codes in a dynamic and changeable way, depending on the value of the random number assigned to the symbol and referential position of “zero code” on the list of codes;
f. precisely determined order of execution steps within the process of encoding and decoding each symbol respectively, step by step, for the sender and receiver of information.

2. The change in the value of the used randomly selected number stated in claim 1 is determined by: mutually replacing the position of its units digit with the position of its first digit; adding this whole number to the value of its units digit; subtracting from this whole number the value of its units digit;

3. The change in the position of the used random whole number stated in claim1 is determined by moving this number in a determined direction for a number of places equal to the value of its units digit;

4. The change in the value of the used code stated in claim 1 is determined by appending the used number at the end of the code;

5. The change in the position of the used code stated in claim 1is determined by moving this code in a determined direction for a number of places equal to the value of the first digit of the used number;

6. The change in the referential position of “zero code” stated in claim 1 is determined by the value of the whole natural number which is at that time the pair of the symbol being coded.
